(19) United States
(12) Patent Application Publication
(10) Pub. No.: US 2025/0345923 A1
(43) Pub. Date: Nov. 13, 2025

(54) ATTACHMENT APPARATUS FOR LASER ENGRAVING

(71) Applicant: LensDigital, LLC, Old Bridge, NJ (US)

(72) Inventor: Leonid Karchevsky, Morganville, NJ (US)

(73) Assignee: LensDigital, LLC, Old Bridge, NJ (US)

(21) Appl. No.: 19/203,136

(22) Filed: May 8, 2025

Related U.S. Application Data
(60) Provisional application No. 63/644,479, filed on May 8, 2024.

(51) Int. Cl. B25H 1/10

(52) U.S. Cl. CPC B25H 1/10

(57) ABSTRACT

An attachment apparatus for laser engraving includes a chuck housing, a scroll wheel in mechanical communication with a plurality of self-centering jaw bases, at least one jaw extender configured to secure to any of the plurality of self-centering jaw bases, and at least one interchangeable jaw configured to secure to any of the at least one jaw extenders. Each jaw base comprises at least one jaw base hole. Each of the at least one jaw extenders comprises two of the at least one interchangeable jaws. The scroll wheel can be actuated to move the self-centering jaw bases, allowing the interchangeable jaws to engage with a surface of an article to secure it for laser engraving. The apparatus may include adjustable alignment stoppers, and the jaw extenders may be configured to rotate for improved contact with the article surface.

### CROSS-REFERENCE TO RELATED APPLICATION

The present application claims priority to U.S. Application No. 63/644,479, titled AN ATTACHMENT APPARATUS FOR LASER-ENGRAVING, filed May 8, 2024, which is hereby incorporated by reference in its entirety.

### FIELD OF THE INVENTION

The present technology relates generally to an attachment apparatus within the field of laser engraving. Specifically, the present disclosure is directed to a rotary attachment apparatus for holding an article during a laser engraving process.

### INTRODUCTION

Light Amplification by Stimulated Emission of Radiation, colloquially referred to as a “laser,” is an artificially created beam of light. The beam of light emitted from a laser is comprised of a plurality of individual light waves, wherein the individual waves travel through space in synchronicity. Meaning, the individual waves of light travel in phase. Lasers, first created in 1960, were originally used for the purpose of furthering scientific understanding of atomic physics and chemistry. However, over time lasers made their way into manufacturing processes across a multitude of industries and today they are utilized for everything from cat toys to surgical procedures.

One use of lasers today is for engraving various tangible articles. Consequently, rotary attachments were developed for simultaneously clasping and rotating said articles allowing a laser engraver to engrave text and/or graphics on the articles. Traditionally, there are two variations of a rotary attachment: (1) a roller-style attachment; and (2) a chuck-style attachment. The roller-style attachments utilize a set of rollers, facilitating rotation of an article, when placed upon said rollers, by employing the force of friction. The chuck-style attachments promote rotational movement of an article by securing said article in a set of jaws capable of rotating.

One benefit of chuck-style rotary attachments is the jaws may alleviate the issue of articles slipping off the rotary attachment, which is a common impediment when using roller-style rotary attachments. However, contemporary chuck-style rotary attachments are overly cumbersome and are adapted for work involving heavy metal parts; meaning, said attachments are poorly suited for holding delicate articles, such as glassware, which can be easily broken or deformed by the metal jaws employed by chuck-style rotary attachments. Additionally, traditional chuck-style rotary attachments in most cases do not have tilting capabilities which limit the use of tapered objects because, in some cases, the inability to tilt an article's surface hinders the laser engraver from effectively engraving said article. Further, traditional chuck-style rotaries are limited in the dimensions of articles they can accommodate, which results from both the chuck height and the reach of the jaws.

The prior art fails to provide a solution to securely gripping a variety of differently shaped objects. Existing clamping devices either require multiple, interchangeable gripping devices, where each gripping device is designed to grip an article of particular shape and size. When a laser engraving device is used for a variety of objects ranging from pens/pencils to tumblers to buckets and vases, a large amount of different gripping devices may be needed. Obtaining and maintaining such a collection is very expensive, tiresome, and can take up much needed space.

Traditional gripping components often suffer from limited holding power and inconsistent stability, especially under heavy or irregular loads. Traditional gripping designs typically rely on a single jaw point, which can lead to slippage, uneven pressure distribution, and reduced control during precision operations. The improved jaw extender described below aims to solve these issues by enabling the use of two finger jaws instead of one, doubling the contact area for a stronger, more stable grip that improves performance across demanding applications.

Accordingly, it would be desirable to provide a chuck-style rotary attachment for laser engraving configured to clamp a variety of articles in a variety of ways that does not require significant storage space or adjustment to accommodate for various articles.

### SUMMARY

This Summary is provided to introduce a selection of concepts in a simplified form that are further described below in the Detailed Description. This Summary is not intended to identify key features or essential features, nor is it intended to limit the scope of the claims included herewith.

An attachment apparatus for laser engraving comprising a chuck housing and a scroll wheel is provided. The chuck housing may comprise a plurality of channels, a plurality of self-centering jaw bases disposed within the plurality of channels, and the plurality of self-centering jaw bases further comprising at least one jaw base hole. The scroll wheel may be in mechanical communication with the plurality of self-centering jaw bases.

The attachment apparatus may further comprise at least one jaw extender configured to secure with any of the at least one jaw base holes and at least one interchangeable jaw. In one embodiment, the at least one interchangeable jaw may be two interchangeable jaws secured to each of the at least one jaw extenders. The at least one jaw extender may comprise an extender base and at least one stopper extending off of the extender base. In an embodiment, the at least one stopper may be two stoppers, each extending off of the jaw extender in line with two interchangeable jaws. In another embodiment, the at least one stopper may be one stopper integrated with the jaw extender.

In one embodiment, the at least one jaw extender may comprise at least one tab extending off a bottom surface 608 of the jaw extender. The at least one jaw extender may be two tabs, each disposed of on opposite sides of one of the plurality of self-centering jaw bases when secured. In some embodiments, the at least one jaw extender may be configured to at least partially rotate, or swivel, relative to the self-centering jaw bases. It is contemplated that by allowing the at least one jaw extender to swivel, the two interchangeable jaws may be positioned to improve surface area contact with an article to be held.

The attachment apparatus may further comprise a plurality of adjustable stoppers disposed within the plurality of channels. In an embodiment, each of the plurality of self-centering jaw bases are disposed radially equidistant. In an embodiment, clockwise actuation of the scroll wheel is configured to radially move each of the plurality of self-centering jaw bases in a first direction and counterclockwise actuation of the scroll wheel is configured to radially move each of the plurality of self-centering jaw bases in a second direction.

In an aspect of the present disclosure, a jaw extender may comprise: an extender body comprising: a top surface and a bottom surface; a center hole; a first wing and a second wing, wherein each of the first wing and the second wing are surrounding a jaw aperture; a first bulbous portion disposed between the first wing and the second wing; a second bulbous portion disposed between the first wing and the second wing, the second bulbous portion extending opposite of the first bulbous portion; and a first core and a second core, each configured to removably couple to the extender body via one of the jaw apertures.

In an aspect of the present disclosure, the top surface and the bottom surface are joined by a continuous sidewall, wherein the continuous sidewall is orthogonal to both the top surface and the bottom surface, and wherein the top surface is parallel to the bottom surface.

In an aspect of the present disclosure, the center hole comprises a countersunk portion on the top surface and a flush portion on the bottom surface.

In an aspect of the present disclosure, each of the first wing and the second wing are defined by chamfered corners.

In an aspect of the present disclosure, the attachment apparatus is further comprising a first flange and a second flange disposed on the bottom surface, wherein the first flange and the second flange are disposed in parallel to one another.

In an aspect of the present disclosure, the first bulbous portion has a protrusion distance greater than that of the second bulbous portion, the protrusion distance for each of the first bulbous portion and the second bulbous portion measured from a center point of the center hole.

In an aspect of the present disclosure, the first bulbous portion is defined by a width greater than that of the second bulbous portion.

In an aspect of the present disclosure, a first jaw protuberance is configured to coaxially encapsulate the first core and a second jaw protuberance is configured to coaxially encapsulate the second core.

In an aspect of the present disclosure, an article attaching apparatus for a laser engraving device, the article attaching apparatus may comprise: a jaw extender comprising: an extender body comprising: a top surface and a bottom surface; a center hole; a first wing and a second wing, wherein each of the first wing and the second wing are surrounding a jaw aperture; a first bulbous portion disposed between the first wing and the second wing; a second bulbous portion disposed between the first wing and the second wing, the second bulbous portion extending opposite of the first bulbous portion; and a first jaw protuberance and a second jaw protuberance, each configured to threadedly attach to the extender body via one of the jaw apertures; and a chuck housing configured to couple to the jaw extender.

In an aspect of the present disclosure, a shoulder bolt extending through the center hole rotatably couples the jaw extender to the chuck housing.

In an aspect of the present disclosure, the jaw extender is configured to rotate so that both the first protuberance and the second protuberance contact a surface of the article.

In an aspect of the present disclosure, the article attaching apparatus is further comprising a plurality of jaw extenders configured to grip an article.

In an aspect of the present disclosure, the plurality of jaw extenders are rotatably coupled to the chuck housing, and wherein each jaw extender of the plurality of jaw extenders are configured to rotate so that both the first protuberance and the second protuberance of each jaw extender contact a surface of the article.

In an aspect of the present disclosure, the first bulbous portion is configured to stabilize an article.

In an aspect of the present disclosure, the top surface and the bottom surface are joined by a continuous sidewall, wherein the continuous sidewall is orthogonal to both the top surface and the bottom surface, and wherein the top surface is parallel to the bottom surface.

In an aspect of the present disclosure, the center hole comprises a countersunk portion on the top surface and a flush portion on the bottom surface.

In an aspect of the present disclosure, each of the first wing and the second wing are defined by chamfered corners.

In an aspect of the present disclosure, the article attaching apparatus is further comprising a first flange and a second flange disposed on the bottom surface, wherein the first flange and the second flange are disposed in parallel to one another.

In an aspect of the present disclosure, the first bulbous portion has a protrusion distance greater than that of the second bulbous portion, the protrusion distance for each of the first bulbous portion and the second bulbous portion measured from a center point of the center hole.

In an aspect of the present disclosure, the first bulbous portion is defined by a width greater than that of the second bulbous portion.

### BRIEF DESCRIPTION OF THE DRAWINGS

The incorporated drawings, which are incorporated in and constitute a part of this specification exemplify the aspects of the present disclosure and, together with the description, explain and illustrate principles of this disclosure.

FIG. 1 is an illustration of an attachment apparatus with bulbous portions extending from the jaw extender in accordance with one or more embodiments of the present disclosure;

FIG. 2 is an illustration of an exploded view of one embodiment of the device with bulbous portions extending from the jaw extender in accordance with one or more embodiments of the present disclosure;

FIG. 3 is an exploded view of one embodiment of the jaw extender with bulbous portions extending from the jaw extender and interchangeable jaws in accordance with one or more embodiments of the present disclosure;

FIG. 4A is an illustration of a front view of a jaw extender with bulbous portions extending from the jaw extender in accordance with one or more embodiments of the present disclosure;

FIG. 4B is an illustration of a rear view of a jaw extender with bulbous portions extending from the jaw extender in accordance with one or more embodiments of the present disclosure;

FIG. 5 shows one embodiment of the attachment apparatus in use in accordance with one or more embodiments of the present disclosure;

FIG. 6 shows an embodiment of the attachment apparatus in use in accordance with one or more embodiments of the present disclosure;

FIG. 7 is an illustration of an attachment apparatus with jaw stoppers extending from the jaw extender in accordance with one or more embodiments of the present disclosure;

FIG. 8 is an illustration of an exploded view of one embodiment of the device with jaw stoppers extending from the jaw extender in accordance with one or more embodiments of the present disclosure;

FIG. 9A is an exploded rear view of one embodiment of the jaw extender with protruding jaw stoppers in accordance with one or more embodiments of the present disclosure;

FIG. 9B is an exploded front view of the embodiment of the jaw extender with protruding jaw stoppers in accordance with one or more embodiments of the present disclosure; and

FIG. 10 is an exploded view of one embodiment of the jaw extender with a jaw stopper and interchangeable jaws in accordance with one or more embodiments of the present disclosure.

### DETAILED DESCRIPTION

In the following detailed description, reference will be made to the accompanying drawing(s), in which identical functional elements are designated with like numerals. The aforementioned accompanying drawings show by way of illustration, and not by way of limitation, specific aspects, and implementations consistent with principles of this disclosure. These implementations are described in sufficient detail to enable those skilled in the art to practice the disclosure and it is to be understood that other implementations may be utilized and that structural changes and/or substitutions of various elements may be made without departing from the scope and spirit of this disclosure. The following detailed description is, therefore, not to be construed in a limited sense.

It is noted that description herein is not intended as an extensive overview, and as such, concepts may be simplified in the interests of clarity and brevity.

All documents mentioned in this application are hereby incorporated by reference in their entirety. Any process described in this application may be performed in any order and may omit any of the steps in the process. Processes may also be combined with other processes or steps of other processes.

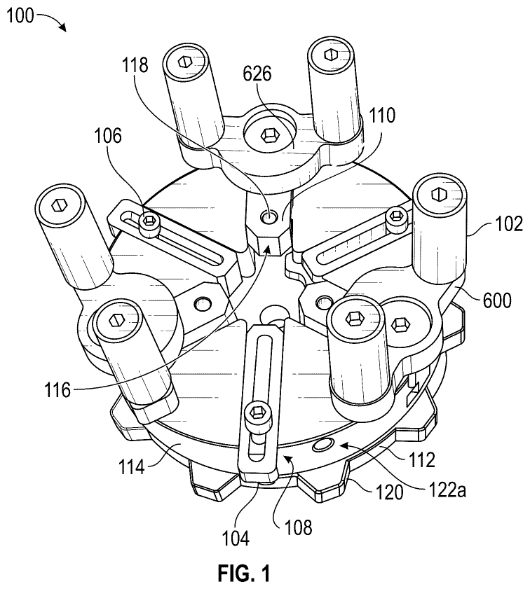

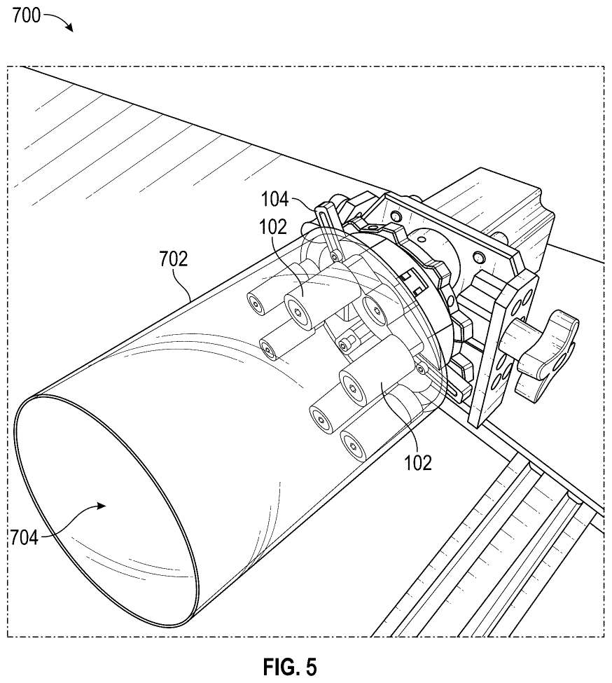

Described herein is an attachment apparatus configured for laser engraving (the “Attachment” or “chuck”). In the embodiments shown in FIG. 1 and FIG. 5, a chuck 100 may comprise interchangeable jaws 102 and a plurality of adjustable alignment stoppers 104. The chuck 100 may further comprise at least one self-centering jaw base 110 and/or a scroll wheel 112. The at least one self-centering jaw base 110 may be disposed upon the chuck housing 114. In a nonlimiting example, a jaw base channel(s) 116 may be formed within a face of the chuck housing 114, wherein said jaw base channel(s) 116 is configured to house the at least one self-centering jaw base 110. In such a nonlimiting example, the at least one self-centering jaw base 110 may have at least one channel hole 118, wherein said channel hole 118 may correspond to the jaw base channel 116 the at least one self-centering jaw base 110 is to be housed within. In an embodiment, the at least one self-centering jaw base 110 and the scroll wheel 112 are in mechanical communication, such that rotational actuation of the scroll wheel 112 may translate to linear motion of the at least one self-centering jaw base 110. As a nonlimiting example, the linear motion of the at least one self-centering jaw base 110 may move towards a center of the chuck housing 114 via clockwise rotational actuation of the scroll wheel 112. In a further nonlimiting example, the linear motion of the at least one self-centering jaw base 110 may move away from the center of the chuck housing 114 via counterclockwise rotational actuation of the scroll wheel 112. However, the at least one self-centering jaw base 110 may move away from or towards the center of the chuck housing 114 via either clockwise or counterclockwise actuation of the scroll wheel 112. In an embodiment, each of the at least one self-centering jaw base 110 are configured to move in tandem, such that the actuation of the scroll wheel 112 imparts equal movement in each of the at least one self-centering jaw base 110.

The scroll wheel 112 may be comprised of a plurality of grooves and/or a plurality of tabs 120. In an embodiment, the plurality of grooves and/or the plurality of tabs 120 may allow for a user's fingers to comfortably grip the scroll wheel 112. Such a grip may enable the user to rotationally actuate the scroll wheel 112, wherein said rotational actuation translates to linear motion of the at least one self-centering jaw base 110. In an embodiment, each of the tabs 120 may extend beyond the circumference of the chuck housing 114 and/or each of the grooves may be positioned in line with or shallower than the circumference of the chuck housing 114. Thus, the tabs 120 may extend outside the edge of the scroll wheel 112 and allow the operator's fingers to hold securely and rotate the scroll wheel 112. Such an arrangement promotes adequate manipulation by a user's digits from a number of angles, permitting the at least one self-centering jaw base 110 to include any suitable jutting components or angular jaws without preventing the user from operating the scroll wheel 112.

In another embodiment, the chuck housing 114 may be further comprised of a chuck housing lever hole 122a and/or a scroll wheel lever hole 122b (collectively the “lever holes 122”). The lever holes 122 may be in mechanical communication with the at least one self-centering jaw base 110. In an embodiment, the lever holes 122 may be configured to receive a tool. In such an embodiment, when the tool is received by at least one of the chuck housing lever holes 122a and the scroll wheel lever hole 122b, rotational actuation of the tool may result in linear motion of the at least one self-centering jaw base 110. The lever holes 122 may provide the user with a second way to adjust the at least one self-centering jaw base 110.

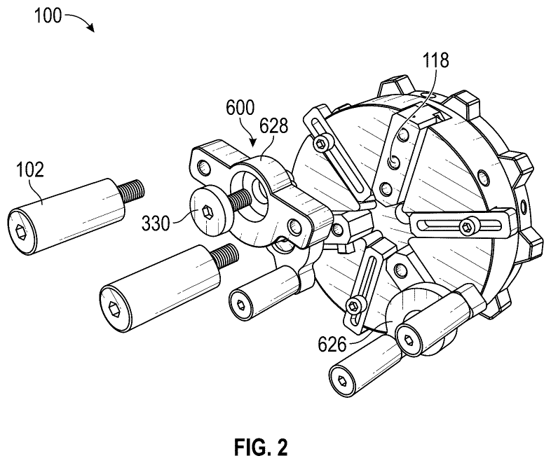

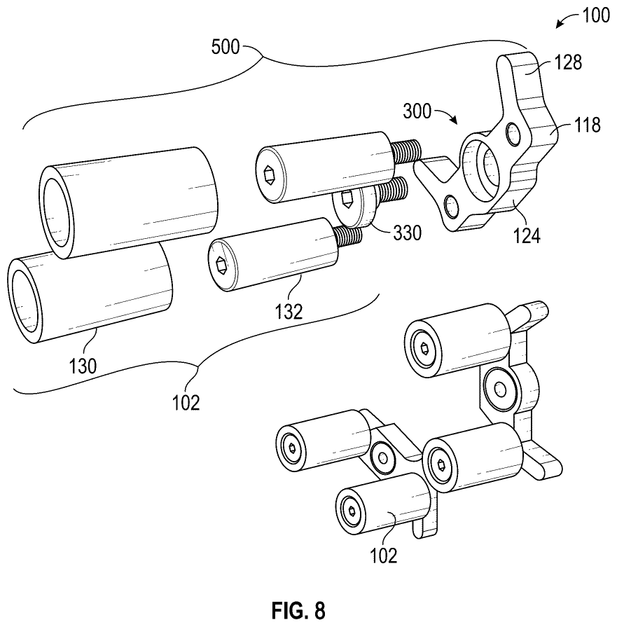

The extender body 600 may be configured to securely receive any of the interchangeable jaws. As illustrated in FIG. 2, each of the extender bodies 600 of the interchangeable jaws assembly 200 may be configured to receive two of the interchangeable jaws 102. The two interchangeable jaws 102 may be positioned on opposite sides of the extender body 600. In other embodiments as shown in FIG. 8, an extender body may include at least one jaw stopper 128. Further, in some embodiments, the at least one jaw stopper 128 may be two jaw stoppers 128 and may extend from the extender body 300 in line with each of the interchangeable jaws 102. As illustrated, each jaw stopper 128 may extend from the extender body 300 at an outward angle and thus, less than all the jaw stopper 128 may be in line with the interchangeable jaws 102.

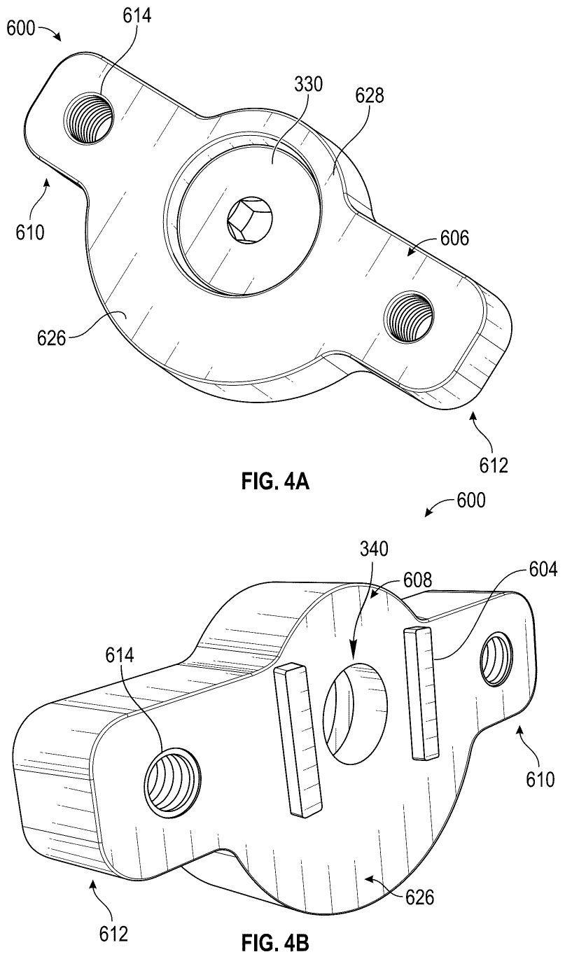

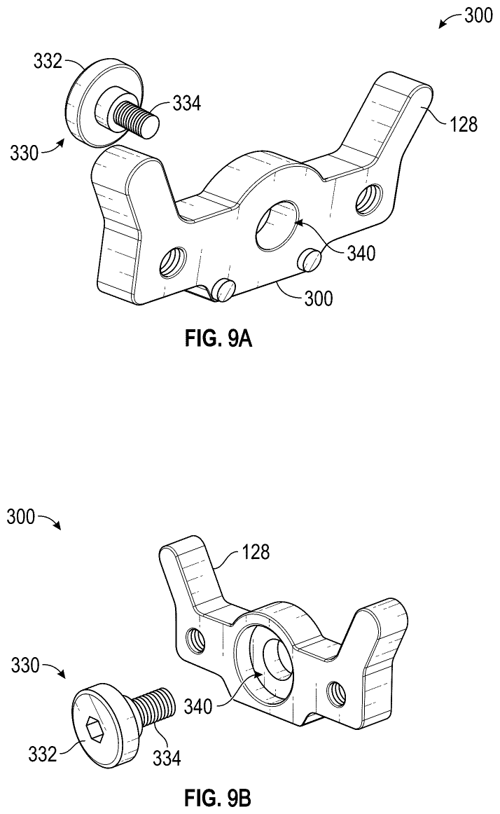

However, in another embodiment, such as the embodiments shown in FIG. 2, FIG. 4A, and FIG. 4B, the extender body 600 may include the at least one first bulbous portion 626, first wing 610, and second wing 612. The first wing 610 and second wing 612 may have chamfered corners. As shown in FIG. 4A and FIG. 4B, the first bulbous portion 626 may extend from a first side of the extender body 600 between the first wing 610 and the second wing 612 and may be formed as a semi-circular or otherwise curved surface. In other embodiments, the jaw extenders may have both jaw stoppers 128 of FIG. 9A and FIG. 9B and first bulbous portion 626. In one or more embodiments, the extender body 600 may include a second bulbous portion 628 opposite the first bulbous portion 626 relative to the center hole 340. The first bulbous portion 626 may have a protrusion distance greater than the protrusion distance of the second bulbous portion 628 measured from a center point of the center hole 340. Further, the first bulbous portion 626 may have a width greater than that of the second bulbous portion 628.

In various embodiments, the first bulbous portion 626 may be sized such that an object to-be-engraved may rest over the extender body 600, such that, for example, the object to-be-engraved rests upon the stoppers integrated with the chuck grip. The second bulbous portion 628 may be sized such that an object to-be-engraved rests upon the second bulbous portion 628 of each of the extender bodies 600 on the chuck grip. Thus, the first bulbous portion 626 and the second bulbous portion 628 may offer differing functionalities in terms of the manner in which they interface with the object to-be-engraved.

In an embodiment, the utilization of two jaws 102 per jaw base 110 provide more gripping power and distributes the load across twice as many jaws 102 over a traditional single jawed embodiment. Accordingly, the jaw extender 600 may be utilized to grip objects of a greater weight than possible with single jawed embodiments. Yet further, use of the jaw extender 600 may allow heavier objects to be engraved without the use of secondary rollers supporting the opposite side of the object to-be-engraved. It is contemplated herein that more than two jaws 102 per jaw base 110 may be used to provide further support.

As shown in FIG. 4B, the extender body 600 may include one or more flanges 604 substantially parallel to one another. The flanges 604 may fit around the self-centering jaw base 110. In some embodiments, the flanges 604 may be spaced apart from each other a distance equal to the width of the jaw base 110. In such an embodiment, the flanges 604 may prevent any rotational motion of the extender body 600. In another embodiment, the flanges 604 may be spaced apart from each other a distance greater than the width of the jaw base 110. In such an embodiment, the extender body 600 may be capable of experiencing rotation limited by the flanges 604. The amount the rotation of the extender body 600 may be dependent upon how much greater the distance between the flanges 604 is than the width of the jaw base 110. A greater distance between the flanges 604 may allow for greater rotation of the extender body 600. A smaller distance between the flanges 604 may allow for less rotation of the extender body 600. In yet another embodiment, only one flange 604 may be present and still sufficiently limit or prevent the rotation of the extender body 600. In still another embodiment, there may be no flanges 604 present. In such an embodiment, the extender body 600 may be configured to rotate in a full 360-degree rotation. Though not shown, extender body 300 may have flanges similar or identical to the flanges 604 of the extender body 600.

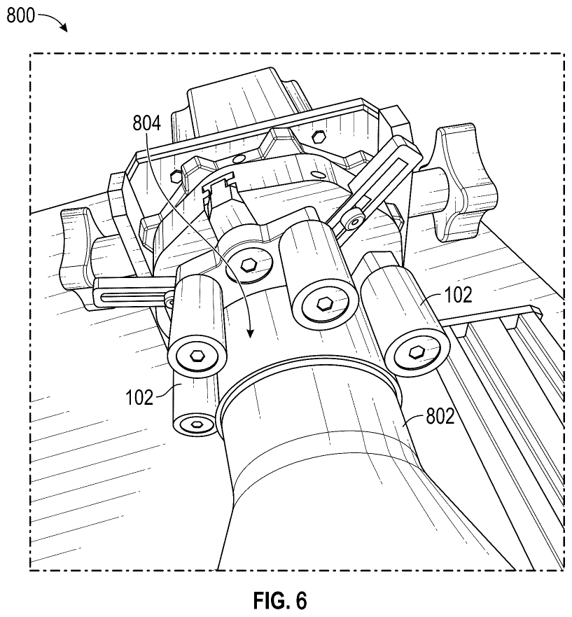

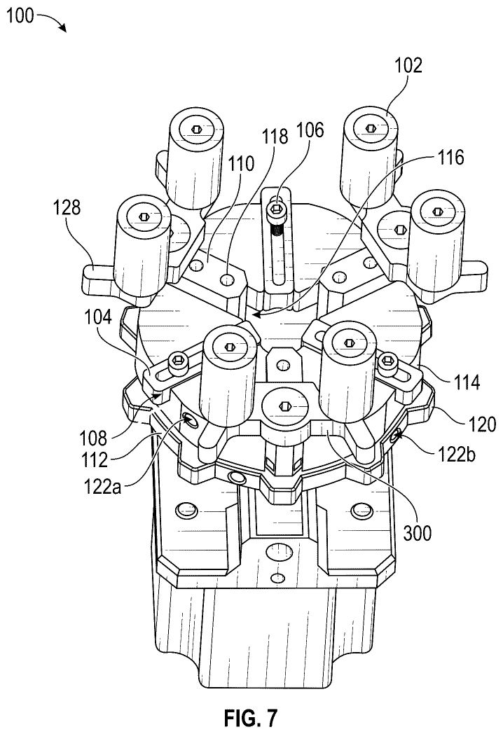

Returning to the embodiment illustrated in FIG. 1, the at least one extender body 600 is configured to secure with the interchangeable jaws 102 and the self-centering jaw base 110. In such an embodiment, rotational actuation of the scroll wheel 112 enables a user to adjust the extender body 600 and thus the interchangeable jaws 102, via the linear motion of the at least one self-centering jaw base 110. In one embodiment, clockwise rotation of the scroll wheel 112 may cause the one or more jaw bases 110 to move in a first direction (e.g., away from the center of the chuck housing 114) and counterclockwise rotation of the scroll wheel 112 may cause the one or more jaw bases 110 to move in a second direction (e.g., toward the center of the chuck housing 114). However, the apparatus may be configured such that the scroll wheel 112 may be rotated in either direction to impart any desired movement in the one or more self-centering jaw bases 110. The adjustment of the interchangeable jaws 102 may allow users to accommodate articles of various sizes such as article 702 and article 802, which may prevent the user from having to change the type of jaws utilized while laser engraving. Further, the adjustment of the interchangeable jaws 102 may obviate a need for further tooling, which may encourage increased storage space for the user. As shown in FIG. 5, the at least one interchangeable jaw may be positioned on an inner surface 704 of the article 702 such that the at least one interchangeable jaw provides an outward force on the inner surface 704 of the article 702 to hold the article 702 in position. In some embodiments, the article 702 may at least partially rest on the adjustable alignment stopper 104 illustrated in FIG. 5, which is contemplated to reduce the movement of the article 702 during use. In other embodiments, the article 702 may at least partially rest on the jaw stopper 128 illustrated in FIG. 7, which is contemplated to reduce movement of the article 702 during use. Another manner of holding the article 802 is shown in FIG. 6, wherein the at least one interchangeable jaw contacts an outer surface 804 of the article 802, providing an inward force on the outer surface 804 of the article 802 to hold the article 802 in position. In such an embodiment, the article 802 may at least partially rest on the jaw stopper 628 illustrated in FIG. 4A and FIG. 4B, which is contemplated to reduce movement of the article 802 during use.

In another embodiment, the extender body 600 may be configured to experience full 360-degree rotation. In such an embodiment, either the extender body 300 or the extender body 600 may be used for gripping either an inner surface 704 of an article 702 or an outer surface 804 of an article 802 depending upon the orientation of the extender body 600. This versatility allows the user to utilize the same jaw extender configuration for various article types without needing to change components. For example, the extender body 300 with jaw stoppers 128 could be rotated to position the jaw stoppers 128 to support an article 802 when gripping the outer surface 804. Similarly, the extender body 600 with the first bulbous portion 626 could be rotated to position the first bulbous portion 626 to support an article 702 when gripping the inner surface 704. The ability to rotate the extender body 600 enables the first bulbous portion 626 to be properly positioned to provide optimal support for the article 702, 802 regardless of whether the interchangeable jaws 102 are gripping an inner or outer surface of the article. The same rotation of extender body 300 may allow for the jaw stopper(s) 128 to have the same functionality as the first bulbous portion 626.

The at least one self-centering jaw base 110 may be comprised of at least one channel hole 118. In an embodiment, the at least one channel hole 118 is threaded. In such an embodiment, the extender body 300 may reversibly couple with the at least one channel hole 118 via a threaded connection, as illustrated in FIG. 2 and FIG. 8. However, the at least one channel hole 118 and the interchangeable jaw may interface via any suitable means. In an alternative embodiment, the at least one channel hole 118 may consist of three channel 118. In such an embodiment, the three channel holes 118 may provide a user with the ability to customize a configuration of the extender body 300 with the at least one self-centering jaw base 110.

The at least one self-centering jaw base 110 may be configured to secure with at least one extender body 300. As illustrated in FIG. 2 and FIG. 8, the extender body 300 may comprise a center hole 340 configured to receive at least one shoulder bolt 330. The center hole 340 may include a countersunk portion on the top surface 606 and a flush portion on the bottom surface 608. The at least one shoulder bolt 330 may extend from a top surface 606 through a bottom surface 608 of the extender body 300. The top surface 606 and bottom surface 608 may be parallel and may be joined by a continuous sidewall. The continuous sidewall may be orthogonal to both the top surface 606 and the bottom surface 608. The extending portion 334 of the shoulder bolt 330 extending from the bottom surface 608 may be configured to secure with any of the at least one channel holes 118. Accordingly, any of the at least one channel holes 118 and the center hole 340 may be aligned such that the at least one shoulder bolt 330 may extend from the top surface 606 of the extender body 300 through the bottom surface 608 and secure with the at least one channel hole 118. Thus, the at least one shoulder bolt 330 may secure the extender body 300 to the jaw base. In one embodiment, a head 332 of the shoulder bolt 330 may protrude slightly from the top surface 606 of the extender body 300 when secured to the jaw base. In various embodiments, although the shoulder bolt 330 is configured to mount the extender body 300 to the jaw base, the shoulder bolt 330 and extender body 600 interface permits the extender body 600 to swivel about the shoulder bolt 330. The extender body 300 may also swivel about shoulder bolt 330 similarly to extender body 600. In an embodiment, the center hole 340 may be sized such that the shoulder bolt 330 top surface sits below the plane of the top surface 606, in the countersunk portion of the center hole 340.

Any of the center holes 340 and the at least one channel hole 118 may be threaded. Likewise, the at least one shoulder bolt 330 may comprise a threading configured to removably secure the at least one shoulder bolt 330 with any of the center holes 340 and the at least one channel hole 118. While the use of a shoulder bolt 330 is described herein, any other fastening means may be used, whether permanent or temporary. In some embodiments the fastening means may be allow rotational motion while in other embodiments, the fastening means may restrict rotational motion.

The plurality of adjustable alignment stoppers 104 may be disposed upon the chuck housing 114. In a nonlimiting example, the plurality of adjustable alignment stoppers 104 may be disposed within an alignment channel 108 of the chuck housing 114, wherein said alignment channel 108 is sized to accept one or more of the plurality of adjustable alignment stoppers 104. In an embodiment, the plurality of adjustable alignment stoppers 104 may be further comprised of an alignment screw 106. In another embodiment, the alignment screw 106 may be threaded. The plurality of adjustable alignment stoppers 104 may be comprised of a jaw base channel 116. In a further embodiment, the alignment screw 106 may be disposed within the jaw base channel 116. In such an embodiment, tightening the alignment screw 106 may lock the plurality of adjustable alignment stoppers 104 in a fixed position, and/or loosening the alignment screw 106 may unlock the plurality of adjustable alignment stoppers 104 allowing said adjustable alignment stoppers 104 to move linearly.

In an embodiment, the apparatus comprises at least three self-centering jaw bases 110. However, the apparatus may include any suitable number of self-centering jaw bases 110. For example, the apparatus may include three, four, or five self-centering jaw bases 110. In various embodiments, the apparatus may include a number and/or configuration of jaw base channels 116 or alignment channels 108 or any chuck housing 114 configuration enabling utilization of the desired number of self-centering jaw bases 110. For example, in an embodiment with four self-centering jaw bases 110, the plurality of jaw base channels 116 may be structured to house the four self-centering jaw bases 110, for example, such that each of the plurality of self-centering jaw bases 110 are disposed radially equidistant from one another. In various embodiments, regardless of the number of self-centering jaw bases 110, each of the self-centering jaw bases 110 may embody any of the configurations described herein.

It is contemplated that in some embodiments, the number of extender bodies 600 may correspond to the number of self-centering jaw bases 110. For example, in the embodiment illustrated in FIG. 1, there are three self-centering jaw bases 110 and three extender bodies 600, such that each of the extender bodies 600 can secure to one of the self-centering jaw bases 110. Each of the extender bodies 600 may be further configured to receive any number of the interchangeable jaws 102 and a total number of interchangeable jaws 102 may be determined according to the number of extender bodies 600. For example, the total number of interchangeable jaws 102 may be six jaws, wherein each of the three extender bodies 600 is configured to receive two interchangeable jaws. It is contemplated that the extender bodies 600 each being configured to receive two interchangeable jaws 102 may increase the strength of the hold of the interchangeable jaws 102. For example, the hold of an embodiment comprising six jaws may be about three-times stronger than the hold of an embodiment comprising three jaws.

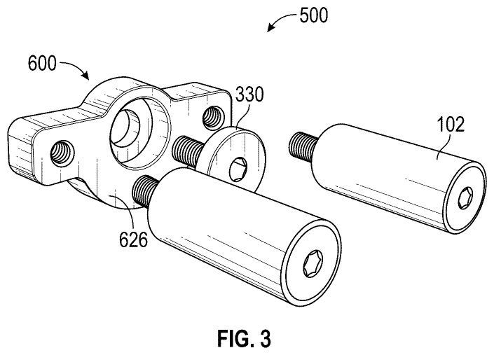

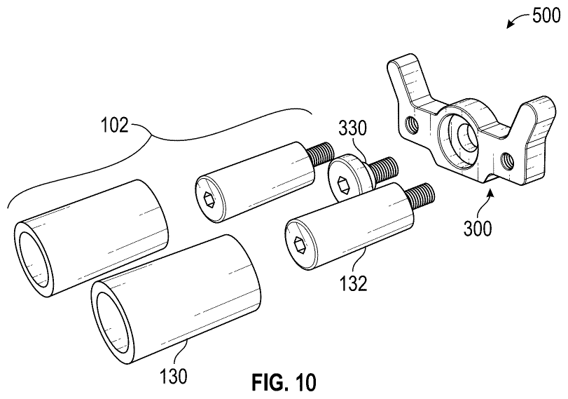

In an embodiment shown in FIG. 10 and FIG. 3, the interchangeable jaws 102 may be comprised of a plurality of rubber fingers or interchangeable jaws 102. The plurality of rubber fingers may be comprised of a core 132 and/or a jaw protuberance 130. In an alternative embodiment, the jaw protuberance 130 may be disposed upon at least one of a rubber finger distal end and a rubber finger proximal end. Further, the plurality of rubber fingers may be further comprised of non-rigid rubber-like material, wherein said material covers the core 132. In an embodiment, the core 132 may be threaded. In another embodiment, the core 132 may be configured to be received by the at least one jaw aperture 614 located in the first wing 610 and/or second wing 612. In such an embodiment, the core 132 may threadedly and reversibly couple to the at least one jaw aperture 614.

FIG. 3 and FIG. 10 each show views of the exploded jaw extender 500 with the interchangeable jaws 102, shoulder bolt 330, and extender body 600. The interchangeable jaws may include a jaw protuberance 130 configured to rotate about the core 132. The core 132 may then be configured to screw or otherwise securely fit into the extender body 600 or the extender body 300.

As a nonlimiting example, the at least one channel hole 118 may be comprised of three channel holes 118, wherein the extender body 600 may be received by any one of the three channel holes 118. In such a nonlimiting example, the ability of the extender body 600 to be received by any one of the three channel holes 118, comprising the at least one channel hole 118, may increase a user level of customizability by allowing said user to alternate between configurations of the rubber fingers with the at least one self-centering jaw base 110. Such customizability may allow a user to adapt the configurations of the jaw extender 500, and thus the rubber fingers with the at least one self-centering jaw base 110 in order to accommodate articles 702, 802 of varying sizes. As a further nonlimiting example, placing the extender body 600 in a first channel hole 118 of the three channel holes 118, comprising the at least one channel hole 118, may allow for the interchangeable jaws 102 to secure small articles 702, 802 such as pens and/or pencils. In yet a further nonlimiting example, placing the extender body 600 in a third channel hole 118 of the three channel holes 118, comprising the at least one channel hole 118, may allow for the interchangeable jaws 102 to secure large articles 702, 802 such as tumblers.

In an embodiment, the rubber fingers may be in the shape of a cylinder. Said cylindrical shape may allow for the rubber fingers to secure an article 702, 802 from at least one of an outside surface and an inside surface of the article 702, 802. Further, the non-rigid rubber-like material, which may comprise an outside surface of the rubber fingers, may enable the interchangeable jaws 102 to secure fragile and/or delicate articles 702, 802, such as glassware. In another embodiment, the non-rigid rubber-like material may increase the force of friction between the rubber fingers and the article 702, 802, thus allowing for the rubber fingers to more securely hold the article 702, 802 during laser engraving. In an alternative embodiment, a rubber finger length may be defined by the distance between the rubber finger distal end and the rubber finger proximal end. In a further embodiment, the plurality of rubber fingers may vary in the rubber finger length. As a nonlimiting example, the plurality of rubber fingers may have a shorter rubber finger length to accommodate smaller articles 702, 802. In such a nonlimiting example, the shorter rubber finger length may enable a user to secure a tapered article 702, 802 within the interchangeable jaws. Further, the shorter rubber finger length may enable a user to secure articles 702, 802 that are comprised of a ridge disposed upon an inside surface of said article 702, 802 within the interchangeable jaws. In a further nonlimiting example, the plurality of rubber fingers may have a longer length to accommodate larger articles 702, 802. Said rubber fingers may be installed and removed by hand without the use of any tools. In alternate embodiments, the rubber fingers may include a set screw or other fastening mechanism, wherein a tool may be utilized for installation and removal of said rubber fingers. In various embodiments, the interchangeable jaws 102 may comprise fingers of various lengths. For example, the interchangeable jaws 102 may be configured with a long finger or a short finger. As a nonlimiting example, the short fingers may be useful for use with tumblers and the like via the inner rims of said tumblers and the like.

As illustrated in FIG. 9A and FIG. 9B, the extender body 300 may comprise a first jaw stopper 128 and a second jaw stopper 128 extending off the bottom surface 608. The first and second jaw stoppers 128 may be disposed of on opposite sides of midline near a proximal edge of the extender body 300. The first and second jaw stoppers 128 may be positioned such that when the extender body 300 is secured, the first and second jaw stoppers 128 are positioned on opposing sides of the extender body 300.

In some embodiments, the extender body 600 may be configured to at least partially rotate about the shoulder bolt 330. More particularly, in one embodiment, the extender body 600 may be configured to swivel about the shoulder bolt 330. By positioning the first and second jaw stoppers 128 on opposing sides of the extender body 600, the flanges 604 may serve as stoppers, preventing a full rotation of the extender body 600. By permitting the extender body 600 to rotate, the interchangeable jaw 102 may likewise be permitted to rotate. It is contemplated that the interchangeable jaw 102 being permitted to rotate may accommodate articles 702, 802 of various shapes. For example, with oval shaped and other non-circular articles 702, 802, permitting any of the interchangeable jaws 102 to be askew relative to another of the interchangeable jaws 102 may improve contact with the article 702, 802, which may improve securement of the article 702, 802. In other embodiments, extender body 300 may have similar rotational features.

In an embodiment, the extender body 600 may be affixed to the jaw bases 110 in two positions, a first position where the first bulbous portion 626 is extending radially away from the center of the chuck grip and a second position where the first bulbous portion 626 is extending radially toward the center of the chuck grip. These positions may allow for the extender body 600 to be utilized with objects of various geometries, for example, accommodating the receiving circumference of the item to-be-engraved. Accordingly, the user may flip the extender body 600 between the first and/or second position to better accommodate different items.

However, in other embodiments, the shoulder bolt 330 may be configured to limit the rotation of the extender body 300 in the absence of the at least one jaw stopper 128.

Various elements, which are described herein in the context of one or more embodiments, may be provided separately or in any suitable subcombination. Further, the processes described herein are not limited to the specific embodiments described. For example, the processes described herein are not limited to the specific processing order described herein and, rather, process blocks may be re-ordered, combined, removed, or performed in parallel or in serial, as necessary, to achieve the results set forth herein.

It will be further understood that various changes in the details, materials, and arrangements of the parts that have been described and illustrated herein may be made by those skilled in the art without departing from the scope of the following claims.

All references, patents and patent applications and publications that are cited or referred to in this application are incorporated in their entirety herein by reference. Finally, other implementations of the disclosure will be apparent to those skilled in the art from consideration of the specification and practice of the disclosure disclosed herein. It is intended that the specification and examples be considered as exemplary only, with a true scope and spirit of the disclosure being indicated by the following claims.

1. A jaw extender comprising:
an extender body comprising:
a top surface and a bottom surface;
a center hole;
a first wing and a second wing, wherein each of the first wing and the second wing are surrounding a jaw aperture;
a first bulbous portion disposed between the first wing and the second wing; and
a second bulbous portion disposed between the first wing and the second wing, the second bulbous portion extending opposite of the first bulbous portion; and
a first core and a second core, each configured to removably couple to the extender body via one of the jaw apertures.

2. The jaw extender of claim 1, wherein the top surface and the bottom surface are joined by a continuous sidewall, wherein the continuous sidewall is orthogonal to both the top surface and the bottom surface, and wherein the top surface is parallel to the bottom surface.

3. The jaw extender of claim 1, wherein the center hole comprises a countersunk portion on the top surface and a flush portion on the bottom surface.

4. The jaw extender of claim 1, wherein each of the first wing and the second wing are defined by chamfered corners.

5. The jaw extender of claim 1, further comprising a first flange and a second flange disposed on the bottom surface, wherein the first flange and the second flange are disposed in parallel to one another.

6. The jaw extender of claim 1, wherein the first bulbous portion has a protrusion distance greater than that of the second bulbous portion, the protrusion distance for each of the first bulbous portion and the second bulbous portion measured from a center point of the center hole.

7. The jaw extender of claim 6, wherein the first bulbous portion is defined by a width greater than that of the second bulbous portion.

8. The jaw extender of claim 1, wherein a first jaw protuberance is configured to coaxially encapsulate the first core and a second jaw protuberance is configured to coaxially encapsulate the second core.

9. An article attaching apparatus for a laser engraving device, the article attaching apparatus comprising:
a jaw extender comprising:
an extender body comprising:
a top surface and a bottom surface;
a center hole;
a first wing and a second wing, wherein each of the first wing and the second wing are surrounding a jaw aperture;
a first bulbous portion disposed between the first wing and the second wing; and
a second bulbous portion disposed between the first wing and the second wing, the second bulbous portion extending opposite of the first bulbous portion; and
a first jaw protuberance and a second jaw protuberance, each configured to threadedly attach to the extender body via one of the jaw apertures; and a chuck housing configured to couple to the jaw extender.

10. The article attaching apparatus of claim 9, wherein a shoulder bolt extending through the center hole rotatably couples the jaw extender to the chuck housing.

11. The article attaching apparatus of claim 10, wherein the jaw extender is configured to rotate so that both the first protuberance and the second protuberance contact a surface of the article.

12. The article attaching apparatus of claim 9, further comprising a plurality of jaw extenders configured to grip an article.

13. The article attaching apparatus of claim 12, wherein the plurality of jaw extenders are rotatably coupled to the chuck housing, and wherein each jaw extender of the plurality of jaw extenders are configured to rotate so that both the first protuberance and the second protuberance of each jaw extender contact a surface of the article.

14. The article attaching apparatus of claim 9, wherein the first bulbous portion is configured to stabilize an article.

15. The jaw extender of claim 9, wherein the top surface and the bottom surface are joined by a continuous sidewall, wherein the continuous sidewall is orthogonal to both the top surface and the bottom surface, and wherein the top surface is parallel to the bottom surface.

16. The jaw extender of claim 9, wherein the center hole comprises a countersunk portion on the top surface and a flush portion on the bottom surface.

17. The jaw extender of claim 9, wherein each of the first wing and the second wing are defined by chamfered corners.

18. The jaw extender of claim 9, further comprising a first flange and a second flange disposed on the bottom surface, wherein the first flange and the second flange are disposed in parallel to one another.

19. The jaw extender of claim 9, wherein the first bulbous portion has a protrusion distance greater than that of the second bulbous portion, the protrusion distance for each of the first bulbous portion and the second bulbous portion measured from a center point of the center hole.

20. The jaw extender of claim 19, wherein the first bulbous portion is defined by a width greater than that of the second bulbous portion.
